(19) United States
(12) Patent Application Publication
(10) Pub. No.: US 2018/0178648 A1
(43) Pub. Date: Jun. 28, 2018

(54) SLIDABLE MOUNTING ASSEMBLY FOR A WORK VEHICLE

(71) Applicant: CNH Industrial America LLC, New Holland, PA (US)

(72) Inventors: Douglas L. Waco, Oak Park, IL (US); Bryan Lee Nannet, Aurora, IL (US); David Dean Flamme, Winfield, IL (US); Dwayne St. George Jackson, Plainfield, IL (US)

(21) Appl. No.: 15/392,549

(22) Filed: Dec. 28, 2016

(51) Int. Cl. B60K 35/00; B60R 11/02; H05K 7/18

(52) U.S. Cl. CPC B60K 35/00; B60R 11/0229; B60R 2011/0084; H05K 7/183; B60R 11/0264

(57) ABSTRACT

The present disclosure is directed to a slidable mounting assembly for a work vehicle includes a mounting bracket configured to couple to a frame member of the work vehicle, and a rail coupled to the mounting bracket. The rail includes a channel that extends substantially along a longitudinal axis of the mounting bracket. A portion of at least one slidable member is configured to be removably disposed within the channel of the rail, and the portion of the at least one slidable member is configured to move along the channel of the rail.

### BACKGROUND

The present disclosure relates generally to a slidable mounting assembly for a work vehicle.

Various types of work vehicles (e.g., tractors, floaters, sprayers, or the like) may be used to plow a field, till land, plant seeds, or accomplish other operations. Certain work vehicles may be coupled to farming implements that are used to accomplish various agricultural operations. Some work vehicles may include monitors, visual devices, or other devices used to monitor and/or control the work vehicle and/or implements coupled to the work vehicle. These devices are typically mounted within the work vehicle in a fixed position. In some cases, the fixed position of the devices may obstruct the view of a work vehicle operator in certain directions. Additionally, in some cases, wires from the devices may further obstruct the view of the work vehicle operator.

### BRIEF DESCRIPTION

In one embodiment, a slidable mounting assembly for a work vehicle includes a mounting bracket configured to couple to a frame member of the work vehicle, and a rail coupled to the mounting bracket. The rail includes a channel that extends substantially along a longitudinal axis of the mounting bracket. A portion of at least one slidable member is configured to be removably disposed within the channel of the rail, and the portion of the at least one slidable member is configured to move along the channel of the rail.

In another embodiment, a slidable mounting assembly for a work vehicle includes a rail with a first portion and a second portion. The first portion of the rail is disposed within a groove of a surrounding structure, and the second portion of the rail is substantially flush with a face of the surrounding structure. A longitudinal extent of the rail is less than a longitudinal extent of the groove, such that a first recess is formed in the surrounding structure proximate to a first longitudinal end of the rail. The first recess is configured to enable insertion and removal of a portion of at least one slidable member.

In a further embodiment, a slidable member includes a base, a fastener, and a mounting member. The fastener is coupled to and extends outwardly from the base, and the mounting member is also coupled to the base. The mounting member includes an opening configured to receive the fastener and secure the mounting member to the base. The base is configured to be removably disposed in and slide along a channel of a rail mounted in a work vehicle.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a work vehicle, in accordance with an aspect of the present disclosure;

FIG. 2 is a perspective view of an embodiment of a slidable mounting assembly positioned within an interior of the work vehicle of FIG. 1, in accordance with an aspect of the present disclosure;

FIG. 3 is a perspective view of an embodiment of a rail of the slidable mounting assembly disposed in a groove of a surrounding structure of the interior of the work vehicle of FIG. 1, in accordance with an aspect of the present disclosure;

FIG. 4 is a perspective view of the slidable mounting assembly coupled to a frame member of the work vehicle of FIG. 1, in accordance with an aspect of the present disclosure;

FIG. 5 is a cross-sectional view of the slidable mounting assembly taken along the line 5-5 of FIG. 3, in accordance with an aspect of the present disclosure; and

FIG. 6 is an exploded view of an embodiment of a slidable member configured to be disposed within the slidable mounting assembly of FIG. 3, in accordance with an aspect of the present disclosure.

### DETAILED DESCRIPTION

The embodiments disclosed herein relate to a slidable mounting assembly configured to receive at least a portion of one or more slidable members. The slidable mounting assembly may be disposed within a cabin of a work vehicle. Additionally, the work vehicle may tow and/or otherwise couple with one or more implements. The one or more implements may each include separate control devices (e.g., monitors having touch screen controls and/or buttons). The control devices may be mounted within the cabin of the work vehicle to enable an operator to control or otherwise adjust operating parameters of the one or more implements. Unfortunately, typical mounting systems in work vehicles fix the control devices in a single position, which may obstruct the view of a work vehicle operator in certain directions.

Accordingly, embodiments of the present disclosure relate to a slidable mounting assembly for a work vehicle that enables display and/or control devices to move within the work vehicle. The slidable mounting assembly may include a rail disposed in a groove of a surrounding structure (e.g., headliner) of the work vehicle. In some embodiments, the rail may be disposed within the groove of the surrounding structure such that the rail is flush with a face (e.g., show surface) of the surrounding structure. Disposing the rail in such a manner may enable monitors, visual devices, or other suitable devices used to monitor and/or control the work vehicle and/or the implements to be positioned closer to the surrounding structure, and thus, reduce visual obstructions for a work vehicle operator. In some embodiments, the rail may be positioned in a manner such that the groove in the surrounding structure includes a length (e.g., a longitudinal extent) greater than a length (e.g., a longitudinal extent) of the rail, such that a recess may be formed between the surrounding structure and the rail (e.g., a portion of the groove not covered by the rail). Additionally, the recess may contain openings that can be used as wireways that receive and direct wires from the monitors or other devices into a space within the surrounding structure, such that the wires may be substantially hidden from the view of the work vehicle operator. Accordingly, disposing wires in the wireways may further reduce visual obstructions for the work vehicle operator.

The rail may include a channel configured to receive at least a portion of one or more slidable members. The recess formed proximate to an end the rail and the surrounding structure may enable the portion of the slidable members to be inserted or removed from the channel of the rail via an open end of the rail at the recess. Additionally, the slidable members may be coupled to a monitor/device. Thus, a slidable member coupled to a monitor/device may be slid by the work vehicle operator along the channel to a desired position that reduces visual obstructions. Accordingly, as discussed herein, the portion of the slidable member may move along the channel of the rail to position a respective monitor/device in a desired position.

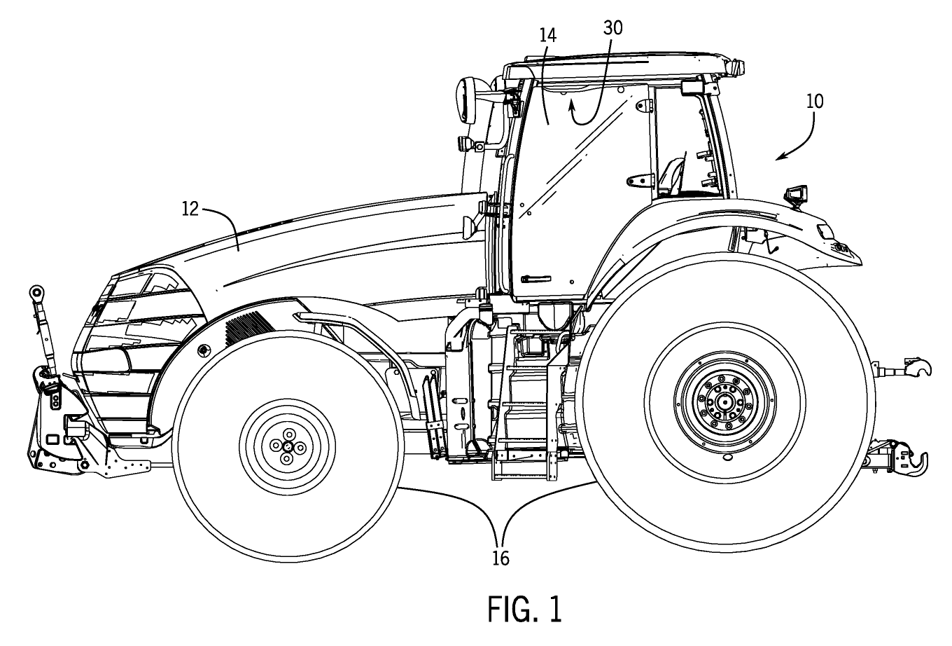

With the foregoing in mind, FIG. 1 is a side view of a work vehicle 10 having a slidable mounting assembly 30. In the illustrated embodiment, the work vehicle 10 is an agricultural tractor. However, any suitable work vehicle, including combines, trucks, and so forth, may utilize aspects of the disclosed embodiments. In the illustrated embodiment, the work vehicle 10 includes a body 12 and a cabin 14, in which an operator may sit to operate the work vehicle 10. The body 12 may house an internal combustion engine, a transmission, and a power train for driving one or more wheels 16. It should be understood that in some such vehicles, the wheels 16 may be replaced with tracks or other drive systems. As discussed in more detail below, the cabin 14 of the work vehicle 10 includes a slidable mounting assembly 30. The slidable mounting assembly 30 may be configured to receive and enable the movement of one or more monitors and/or other visual and/or control devices. Accordingly, the operator of the work vehicle 10 may adjust a position of the monitors and/or other visual and/or control devices to reduce or eliminate visual obstructions in a desired viewing direction of the work vehicle operator. Moreover, while in the illustrated embodiment the slidable mounting assembly 30 is located on a roof of the work vehicle 10, the slidable mounting assembly 30 may be positioned in any other suitable area of the work vehicle 10. For example, the slidable mounting assembly 30 may be mounted to the sides, interior walls, door frames, and/or window frames of the work vehicle 10.

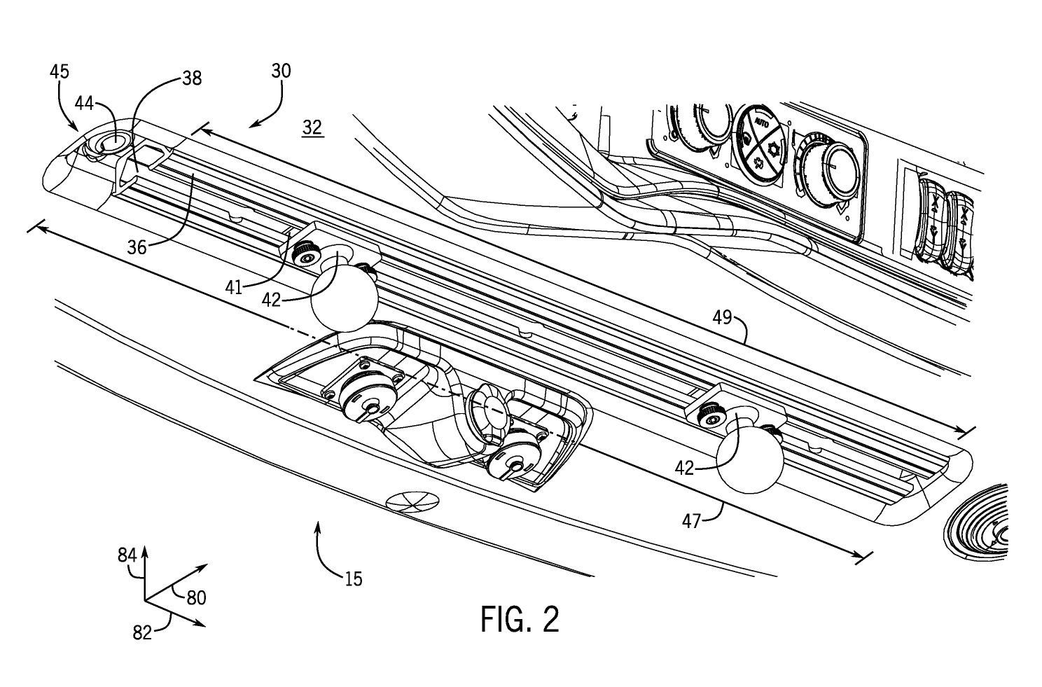

FIG. 2 is a perspective view of an embodiment of the slidable mounting assembly 30 disposed within an interior 15 in the work vehicle 10 of FIG. 1. To facilitate discussion, a set of axes are referenced. The axes include a lateral axis 80, a longitudinal axis 82, and a vertical axis 84. The cabin 14 of the work vehicle 10 may include a surrounding structure 32 (e.g., a headliner). In some embodiments, the slidable mounting assembly 30 includes a groove 34 in the surrounding structure 32 and a rail 36. A channel 38 may be located within the rail, and a recess 40 may be located proximate to a longitudinal end 45 of the rail between the surrounding structure 32 and the rail 36. At least a portion (e.g., a base 41) of one or more slidable members 42 may be disposed within the channel 38 of the rail 36. The rail 36 is coupled to components (e.g., a frame) of the work vehicle 10. In the illustrated embodiment, the groove 34 is formed within the surrounding structure 32. However, in other embodiments, the groove 34 may be separate from the surrounding structure 32. For example, the groove 34 may be included in a component that may be mounted or coupled to the surrounding structure 30.

In any case, the rail 36 is disposed within the groove 34 such that the rail 36 extends substantially along the longitudinal axis 82 of the groove 34. The groove 34 extends beyond the rail 36 along the longitudinal axis 82 on at least one longitudinal end (e.g., the longitudinal end 45) such that a recess 40 may be formed proximate to the longitudinal end 45 of the rail 36. Accordingly, a first longitudinal extent 47 of the groove 34 may be greater than a second longitudinal extent 49 of the rail 36 such that the recess 40 is not entirely occupied by the rail 36. The recess 40 is configured to enable and facilitate insertion and/or removal of the one or more slidable members 42 from the rail 36. Moreover, it should be noted that there may be more than one recess 40. For instance, a second recess may be formed proximate to another longitudinal end of the rail 36.

In some embodiments, the rail 36 may be angled within the groove 34. In other words, the rail 36 may be placed such that the rail 36 does not extend along the longitudinal axis 82 at the same angle as to the groove 34. However, in the illustrated embodiment, the rail 36 substantially extends along the longitudinal axis 82 (e.g., within 0 and 45 degrees of, within 0 and 15 degrees of, or between 0 and 5 degrees of).

The channel 38 is formed in the rail 36 such that the channel 38 extends substantially along the longitudinal axis 82 of the groove 34. The channel 38 is configured to removably receive at least a portion (e.g., the base 41) of the one or more slidable members 42 on the longitudinal end 45 of the channel 38 (e.g., an end adjacent to the recess 40). In other embodiments, the channel 38 may removably receive at least the portion (e.g., the base 41) of the one or more slidable members 42 on an additional longitudinal end, opposite the longitudinal end 45. In still further embodiments, the portion (e.g., the base 41) of the one or more slidable members 42 may be inserted into the channel 38 before the rail 36 is disposed in the groove 34. Accordingly, each slidable member 42 may move along the rail 36, such that a longitudinal position of a monitor/device coupled to the slidable member 42 is adjusted. In some embodiments, the entirety of each slidable member 42 may be configured to be removably inserted and/or removed from the channel 38 of the rail 36.

The recess 40 enables the portion (e.g., the base 41) of each slidable member 42 to enter the channel 38 at the longitudinal end 45. In other embodiments, at least a portion of the slidable members 42 may be inserted into the channel 38 without passing through the recess 40 (e.g., a portion of the slidable members 42 may be inserted into the channel 38 before the rail 36 is disposed in the groove 34). Each slidable member 42 may be coupled to one or more monitors and/or other electronic devices that enable the operator of the work vehicle 10 to control and/or observe operating parameters of the work vehicle 10 and/or one or more implements coupled to (e.g., towed) by the work vehicle. Alternatively, in other embodiments, a channel may instead be located in each of the one or more slidable members 42, such that the one or more slidable members 42 receive a protrusion of the rail 36. For example, the rail 36 may include a protrusion that substantially extends along the longitudinal axis 82, and the one or more slidable members 42 may include corresponding slots (e.g., channels) that receive the protrusion. Thus, the one or more slidable members 42 may be placed around the protrusion via the slots, and the one or more slidable members may be adjusted by the work vehicle operator by sliding the one or more slidable members along the protrusion (e.g., substantially along the longitudinal axis 82). By adjusting the position of the one or more slidable members 42 along the protrusion, the work vehicle operator may reduce the visual obstructions that may be caused by monitors and/or other electronic devices that may be included in the work vehicle 10.

Furthermore, an opening is formed in the surrounding structure 32 and includes an inlet at the recess 40. The opening creates a wireway 44 for receiving power cords and/or other wires corresponding to the devices mounted to the slidable member(s) 42. One or more electrical and/or communicative wires may extend through the wireway 44 such that the wires may be connected to one or more monitors and/or other electronic devices mounted to the slidable members 42. In other embodiments, the wireway 44 may be formed in another suitable location in the surrounding structure 32 (e.g., at another portion of the groove), such that the wires can extend from monitors/devices to a power source, an implement, another receiver or control device of the work vehicle 10, or a combination thereof. Disposing the wires through the wireway 44 may reduce visual obstructions.

In some embodiments, the groove 34 and/or the rail 36 may be positioned in elements other than the surrounding structure 32. For example, there may be a break (e.g., a gap) in the surrounding structure 32, and the groove 34 and/or the rail 36 may be positioned in the break. In such an embodiment, the groove 34 and/or the rail 36 may be positioned above the surrounding structure 32 but still within the interior 15 of the cabin 14. Additionally, in other embodiments, the groove 34 and/or the rail 36 may be positioned in another suitable location of the cabin 14 (e.g., along a window or a door of the vehicle 10).

In the illustrated embodiment of FIG. 2, the rail 36 is disposed within the groove 34 of the surrounding structure 32 such that the rail 36 is flush with a face (e.g., show surface) of the surrounding structure 32. However, in other embodiments, the rail may be disposed within the groove 34 such that the rail 36 is not flush with a face of the surrounding structure 32. In other words, the rail 36 may extend into the surrounding structure or protrude away from the surrounding structure (e.g., along the axis 84).

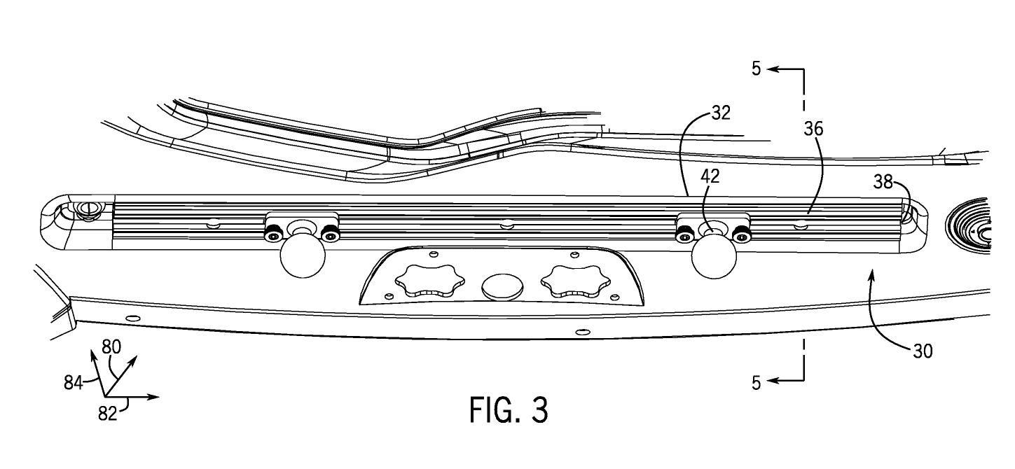

FIG. 3 is a perspective view of the slidable mounting assembly 30 disposed within the interior of the work vehicle of FIG. 1. In the illustrated embodiment, portions of two slidable members 42 are disposed within the channel 38 of the rail 36. However, the slidable mounting assembly 30 may be configured to receive 1, 2, 3, 4, 5, 6, 7, 8, 9, 10, or more slidable members 42. Additionally, the cabin 14 of the work vehicle 10 may include the surrounding structure 32 (e.g., a headliner). In some embodiments, the surrounding structure 32 may cover components of the slidable mounting assembly 30 and/or the work vehicle structure to conceal such components from the work vehicle operator. In the illustrated embodiment, the surrounding structure 32 includes a headliner. The headliner may include materials such as cloth, plastic, and/or other suitable materials to enhance an aesthetic quality of the cabin 14. However, in other embodiments, the surrounding structure 32 may include another component (e.g., a roof) of the work vehicle 10.

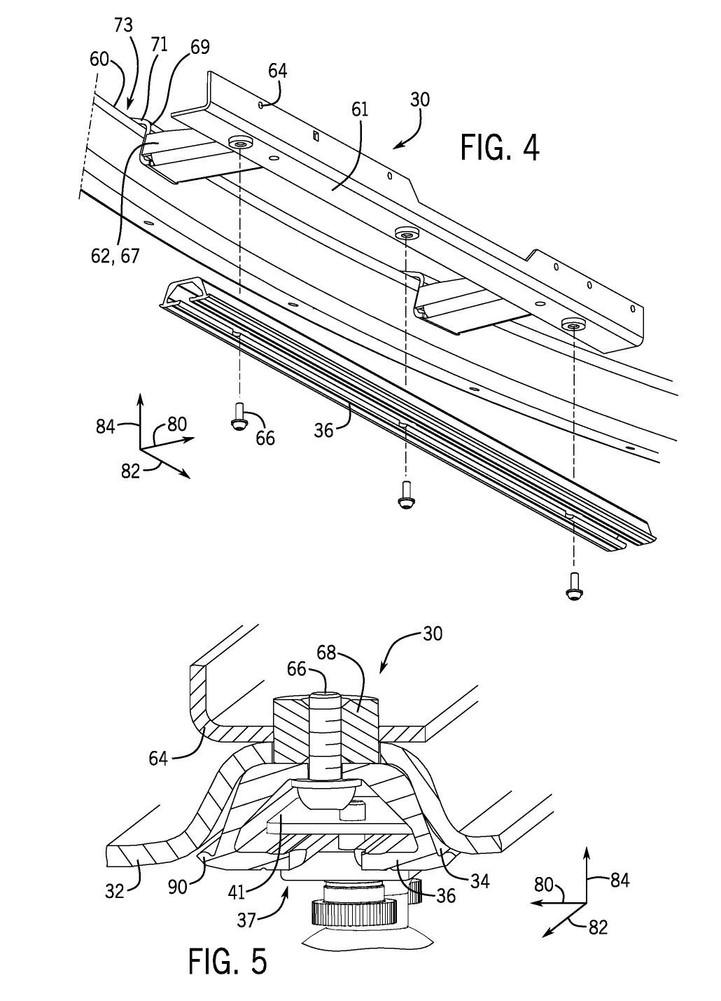

Regardless of the surrounding structure 32, the slidable mounting assembly 30 may be coupled to the work vehicle structure (e.g., frame, cab, etc.) such that the slidable mounting assembly 30 is substantially fixed with respect to the work vehicle structure. For example, FIG. 4 is a perspective view of the slidable mounting assembly 30 coupled to a frame member 60 of the work vehicle 10. The frame member 60 may be a component of a structural frame of the work vehicle.

In the embodiment of FIG. 4, the rail 36 of the slidable mounting assembly 30 generally extend along the longitudinal axis 82 (extend parallel to the longitudinal axis 82 or at an angle that is between 0 and 45 degrees relative to the longitudinal axis 82) and is configured to be coupled to a bottom portion 61 of a mounting bracket 64 by one or more fasteners 66 (e.g., threaded bushings). Accordingly, the mounting bracket 64 also generally extends along the longitudinal axis 82 (extend parallel to the longitudinal axis 82 or at an angle that is between 0 and 45 degrees relative to the longitudinal axis 82). The one or more fasteners 66 may extend into the bottom portion 61 of the mounting bracket 64 and/or the rail 36 along the vertical axis 84. However, in other embodiments, the rail 36 may be disposed on another side or portion of the mounting bracket 64. For example, the rail 36 may be disposed partially above the mounting bracket 64, such that a side of the rail 36 is positioned above the mounting bracket 64 with respect to the axis 84, but a portion of the rail 36 is position below the mounting bracket 64 with respect to the axis 84. In such embodiments, the portion (e.g., the base 41) of the slidable member 42 may be inserted and/or removed from the portion of the rail 36 below the mounting bracket 64. Additionally, in other embodiments, the rail 36 of the slidable mounting assembly 30 may be coupled to the mounting bracket 64 without the use of the one or more fasteners 66 (e.g., via welding, via adhesive, etc.). Moreover, in still further embodiments, the rail 36 may not be mounted using the mounting bracket 64. For instance, the rail 36 may be positioned on a floor of the cabin 14 (e.g., via welding, fasteners, etc.).

The mounting bracket 64 includes mounts 62. The mounts 62 may be coupled to the mounting bracket 64 (e.g., welded to the mounts 62) and generally extend along the lateral axis 80 (extend parallel to the lateral axis 80 or at an angle that is between 0 and 45 degrees relative to the lateral axis 80). Additionally, the mounts 62 may extend from the frame member 60 to the mounting bracket 64. In some embodiments, the mounts 62 are coupled to the frame member 60 via welding and/or fasteners, etc. In the illustrated embodiment, two mounts 62 are coupled to the mounting bracket 64 and to the frame member 60. However, in alternative embodiments, 1, 2, 3, 4, 5, 6, 7, 8, 9, 10, or more mounts 62 may couple the mounting bracket 64 and the frame member 60 to one another. In another embodiment, the mounts 62 may be directly coupled to the rail 36 by the one or more fasteners 66 such that the mounting bracket 64 is omitted.

In some embodiments, the mounts 62 may include a first portion 67 and a second portion 69. The first portion 67 may extend from the mounting bracket 64 toward the frame member 60. Additionally, the second portion 69 of the mounts 62 may include a “Z” shape that extends above the first portion 67 with respect to the axis 84. Additionally, the “Z” shape of the second portion 69 enables the second portion 69 to contact two faces 71 and 73 of the frame member 60. In some embodiments, the second portion 69 couples the mounts 62 to the frame member 60 at both of the faces 71 and 73. As such, a strength of the connection between the mounts 62 and the frame member 60 may be enhanced because the connection occurs at multiple faces 71 and 73. While the illustrated embodiment of FIG. 4 shows the first portion 67 having a substantially rectangular cross-section and the second portion 69 having the “Z” shape, it should be noted that the first portion 67 and the second portion 69 may include any other suitable shape that enables a connection between the frame member 60, the mounts 62, and the mounting bracket 64.

As discussed above, in the illustrated embodiment, the frame member 60, the mounts 62, and the mounting bracket 64 may be concealed by the surrounding structure 32 while other components (e.g., the rail 36) may be visible to an operator of the work vehicle 10. However, in other embodiments, any or all of the components may or may not be visible to the operator of the work vehicle 10.

FIG. 5 is a cross-sectional view of the slidable mounting assembly 30. In the illustrated embodiment, the rail 36 is coupled to the mounting bracket 64 by the one or more fasteners 66 and a bushing 68. In the present embodiment, the fastener 66 and the bushing 68 are threaded. However, in other embodiments, the fastener 66 and the bushing 68 may not be threaded. In the present embodiment, the fastener 66 engages the bushing 68 via threaded connection. It should be noted that, in other embodiments, another means could be used to couple the rail 36 to the mounting bracket 64 (e.g., rivets). Additionally, in some embodiments, the bushing 68 may be formed integrally with the mounting bracket 64. In the illustrated embodiment, the bushing 68 is coupled to the mounting bracket 64 (e.g., via welding). The fastener 66 may be inserted into the bushing 68 via movement along the vertical axis 84 and rotation about the vertical axis 84 to mesh the threads of the fastener 66 with the corresponding threads of the bushing 68. In certain embodiments, a nut or other securement device may be coupled to the fastener 66 on the side of the bushing 68 opposite the rail 36, such that the fastener 66 extends through the bushing 68 and is secured by the nut and/or other securement device. In other embodiments, the fastener 66 may be inserted from a top portion of the bushing 68 toward the rail 36. In the illustrated embodiment, the bushing 68 serves as the securement device, such that the fastener 66 is secured to the bushing 68 via a threaded connection between the bushing 68 and the fastener 66. Additionally, a head of the fastener 66 may contact the rail 36 and block movement of the rail 36 along the vertical axis 84. Moreover, upward movement of the rail 36 with respect to the axis 84 is blocked by contact between the rail 36 and the bushing 68.

As illustrated in FIG. 5, a portion of the surrounding structure 32 is disposed between the mounting bracket 64 and the rail 36, such that the rail 36 is disposed in the groove 34 of the surrounding structure 32. The rail 36 includes protrusions 90 extending along the lateral axis 80 protruding away from a longitudinal face 37 of the rail 36 in opposite longitudinal directions. As illustrated, the protrusions 90 create a generally flush interface between the rail 36 and surrounding structure 32 (i.e., a face of the rail 36 and a face of the surrounding structure 32 are level along the longitudinal axis 82 or are spaced between 0.01 centimeters (cm) and 1 cm from one another along the longitudinal axis 82). In other words, the longitudinal side 37 forms the show surface of the rail 36, and the show surface of the rail 36 is substantially flush with a show surface of the surrounding structure 32. A generally flush interface between the rail 36 and the surrounding structure 32 may reduce gaps between the rail 36 and the surrounding structure 32, thereby enhancing an aesthetic appeal of the slidable mounting assembly 30. Moreover, a generally flush interface between the rail 36 and the surrounding structure 32 may reduce or eliminate visual obstructions of the work vehicle operator. Additionally, while the illustrated embodiment includes two protrusions 90, the rail 36 may include more than two protrusions 90 or less than two protrusions.

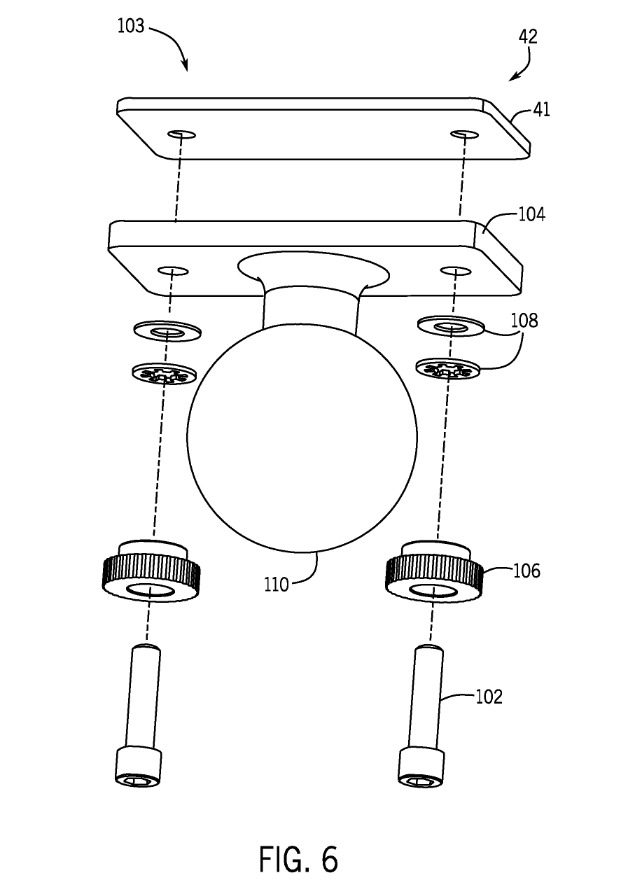

FIG. 6 is an exploded view of an embodiment of a slidable member 42. The slidable member 42 includes a base 41, fasteners 102 (e.g., hex screws), a mounting member 104, securement components 106, washers 108, and a ball mount 110 for mounting the monitor and/or electronic device. The base 41 is coupled to the mounting member 104 by the fasteners 102 and the securement components 106. The base 41 may be disposed within the channel. Once the base 41 is disposed within the channel, the fasteners 102 and/or the securement components 106 of the slidable member 42 may be tightened by the work vehicle operator to block movement (e.g., sliding) of the slidable member 42 along the channel.

In the illustrated embodiment, the fasteners 102 and/or the securement components 106 are threaded. However, in other embodiments, the fasteners 102 and/or the securement components 106 may not be threaded. Additionally, while the present embodiment includes two fasteners 102 and two securement components 106, in other embodiments, there may be more or less than two fasteners 102 and/or securement components 106. Moreover, in other embodiments, one or more openings 103 of the base 41 may be threaded, and the one or more openings 103 may receive the fasteners 102 via a threaded connection. In such embodiments, the fasteners 102 may be positioned in an opposite orientation from that shown in FIG. 6, such that a face of the fastener 102 abuts the mounting member 104 instead of the base 41. In any case, the fasteners 102 and securement components 106 can be used to compress the base 41 and the mounting member 104 against the longitudinal face 37 of the rail. Additionally, the fasteners 102 and/or securement components 106 of the slidable member 42 may be loosened by the work vehicle operator to enable movement (e.g., sliding) of the slidable member 42 along the channel. The securement components 106 may be rotated (e.g., about the axis 84) to tighten and loosen the slidable member 42 without the use of tools. In other embodiments, it may be preferable to use tools (e.g., a screwdriver) to facilitate the tightening and loosening of the securement components 106. The washers 108 may be used to evenly distribute pressure from the securement components 106 across the longitudinal side of the rail as the securement components 106 are tightened. Furthermore, while the illustrated embodiment includes four washers 108, other embodiments may include more or less than four washers 108.

The ball mount 110 is disposed in a receiving portion of a monitor, visual device, or other device used to monitor and/or control the work vehicle and/or implements. In the illustrated embodiment, the mounting member 104 includes the ball mount 110. In other embodiments, the mounting member 104 may include another suitable type of mount or element that enables coupling to a monitor/device. Utilizing the ball mount 110 enables rotation of a mounted monitor/device whereas the base 41 enables the monitor/device to move along the rail 36 to a desired position. Accordingly, the work vehicle operator may adjust a monitor/device as desired by rotating the monitor/device about the ball mount, by sliding the base 41 of the slidable member 42 along the channel, or both.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A slidable mounting assembly for a work vehicle, comprising:
a mounting bracket configured to couple to a frame member of the work vehicle; and
a rail coupled to the mounting bracket, wherein the rail has a channel extending substantially along a longitudinal axis of the mounting bracket, wherein a portion of at least one slidable member is configured to be removably disposed within the channel of the rail, and the portion of the at least one slidable member is configured to move along the channel of the rail.

2. The slidable mounting assembly of claim 1, wherein the mounting bracket comprises at least one mount, wherein the at least one mount extends generally away from the mounting bracket and toward the frame member, and the at least one mount is configured to couple the mouting bracket to a frame member of the work vehicle.

3. The slidable mounting assembly of claim 2, wherein the at least one mount comprises a first portion configured to couple to the mounting bracket and a second portion configured to couple to the frame member, and wherein the second portion is “Z” shaped.

4. The slidable mounting assembly of claim 3, wherein the first portion of the at least one mount is welded to a body of the mounting bracket.

5. The slidable mounting assembly of claim 1, wherein the rail is coupled to the mounting bracket by a fastener.

6. The slidable mounting assembly of claim 5, wherein the fastener comprises a threaded bushing.

7. The slidable mounting assembly of claim 1, wherein an opening is disposed on a longitudinal end of the rail, and the opening is configured to facilitate insertion and removal of the portion of the at least one slidable member.

8. The slidable mounting assembly of claim 1, wherein the at least one sliding member comprises a base, at least one fastener, and at least one mounting member, wherein the portion of the at least one slidable member comprises the base.

9. The slidable mounting assembly of claim 1, wherein the channel of the rail is formed by a side of the rail disposed adjacent to the mounting bracket and two flanges configured to secure the portion of the at least one slidable member within the channel.

10. A slidable mounting assembly for a work vehicle, comprising:
a rail comprising a first portion and a second portion, wherein the first portion of the rail is disposed within a groove of a surrounding structure, the second portion of the rail is substantially flush with a face of the surrounding structure, a longitudinal extent of the rail is less than a longitudinal extent of the groove, such that a first recess is formed in the surrounding structure proximate to a first longitudinal end of the rail, and the first recess is configured to enable insertion and removal of a portion of at least one slidable member.

11. The slidable mounting assembly of claim 10, wherein the surrounding structure has a wireway opening with an inlet at the first recess.

12. The slidable mounting assembly of claim 11, comprising an electronic device configured to couple to the at least one slidable member, wherein a wire of the electronic device extends through the wireway opening.

13. The slidable mounting assembly of claim 10, wherein the surrounding structure comprises a headliner.

14. The slidable mounting assembly of claim 10, wherein a second recess is formed in the surrounding structure proximate to a second longitudinal end of the rail.

15. The slidable mounting assembly of claim 10, wherein the portion of the at least one slidable member comprises a base portion, the rail comprises a channel configured to receive the base portion of the at least one slidable member, and the first recess is configured to facilitate insertion and removal of the base portion.

16. A slidable member, comprising:
a base;
a fastener coupled to and extending through the base; and
a mounting member coupled to the base, wherein the mounting member comprises an opening configured to receive the fastener and secure the mounting member to the base, wherein the base is configured to be removably disposed in and slide along a channel of a rail mounted in a work vehicle.

17. The slidable member of claim 16, wherein the base is configured to be secured in a position along the channel of the rail when the fastener is in a tightened position.

18. The slidable member of claim 17, wherein the fastener comprises a hex screw.

19. The slidable member of claim 16, wherein the mounting member comprises a ball mount.

20. The slidable member of claim 16, wherein a bracket is configured to be coupled to the mounting member, and the bracket is configured to receive a monitor.
